(19) United States
(12) Patent Application Publication
(10) Pub. No.: US 2018/0070693 A1
(43) Pub. Date: Mar. 15, 2018

(54) HANDBAG SYSTEMS AND METHOD

(71) Applicant: DEBRA C. BLOOMFIELD, Tazewell, VA (US)

(72) Inventor: DEBRA C. BLOOMFIELD, Tazewell, VA (US)

(21) Appl. No.: 15/264,437

(22) Filed: Sep. 13, 2016

(51) Int. Cl. A45C 15/00; A45C 3/06; A45C 3/00; A45C 13/10; H02J 7/00; H04B 1/3883

(52) U.S. Cl. CPC A45C 15/00; A45C 3/06; A45C 3/001; A45C 2200/20; H02J 7/0044; H02J 7/0045; H04B 1/3883; A45C 13/103

(57) ABSTRACT

A handbag system and method for combining interactive components and style with an assembly of personal and electronic inner and outer storage compartments, attachable and detachable pockets and straps, an integrated mobile device battery charger, a retractable charging cable, an NFC blocker, a shielded pocket, and securing mechanisms in functional combination.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of a handbag systems and more specifically relates to a handbag having an inbuilt electrical charging means and a plurality of detachable pockets.

### 2. DESCRIPTION OF RELATED ART

From the earliest stages of civilization, bags and purses were practical everyday articles used by men as well as women as they were necessary for carrying money and other personal items since clothes had not yet been fitted with pockets. Bags and purses came in a variety of designs for a number of purposes, such as bags with clasps, leather pouches and purses with long drawstrings. The introduction of pockets towards the end of the 16th century meant that the men's bags slowly disappeared in the course of the 17th century. From then on, bags belonged almost exclusively to the women's domain.

In the 20th century, art and fashion movements came and went in rapid succession and the handbag evolved alongside. However, women's emancipation was the most influential factor in the shaping of the handbag. More and more women were employed and as they became more mobile, their handbags had to meet a growing variety of practical needs. This resulted in all sorts of bags for specific purposes such as leather document cases for going to the office, practical leather and plastic daytime bags for walking and visiting, elegant bags and metal clutches for evening use.

As handbags have long served as a tool to aid in self-expression, personal statements, status symbols, and fashion accessories, handbag functionality remained a primary concern to women when choosing a handbag. Lifestyles of modern women have taken on higher demands, requiring even the average woman to be prepared in business and personal situations at all times. With changes in technology, communications, self-expression, career, and family demands, a functional yet fashionable handbag has become a necessity for the 21^{st} century woman who is most frequently on the go and expects to remain fashionable while doing so.

Several attempts have been made to solve the above-mentioned problems such as those found in U.S. Pat. and Pub. Nos. 2,672,903, 2013/0048164, 9,265,319, and 2016/0058141. This art is representative of handbags. However, none of the above inventions and patents, taken either singly or in combination, is seen to describe the invention as claimed.

### BRIEF SUMMARY OF THE INVENTION

In view of the foregoing disadvantages inherent in the known handbag system art, the present invention provides a novel handbag system and method. The general purpose of the present invention, which will be described subsequently in greater detail is to provide a handbag having an inbuilt electrical charging means, an NFC storage pocket, and a plurality of detachable pockets.

A handbag system is disclosed herein, in a preferred embodiment, comprising a handbag outer shell, a detachable shoulder strap, a first-side handle, a second side-handle, at least one detachable storage pocket, a charging pocket, a shielded pocket, and a set of user instructions configured as a kit.

A method for using handbag systems is also disclosed herein. The method for providing handbag systems and methods may include the steps of: obtaining the augmented handbag, filling at least one elastic sleeve of outer covering with a bottle or thermal beverage container, opening a zip-fastener of outer covering to gain access to inner volume; attaching and alternatively reattaching the storage pockets located alongside inner volume; accessing a first-pocket having a retractable lanyard attachment, built-in mobile device battery charger and a second-pocket having an NFC security blocker; utilizing the first-pocket having a retractable lanyard attachment and built-in mobile device battery charger and second-pocket having an NFC security blocker; closing a zip-fastener of outer covering to secure contents of inner volume; grasping the attached first and second side-handles or detachable shoulder strap; and carrying outer covering with inner contents of inner volume.

The present invention holds significant improvements and serves as a handbag system and method. Preferably, a handbag system should provide an inbuilt electrical charging means and a plurality of detachable pockets and, yet would operate reliably and be manufactured at a modest expense. Thus, a need exists for a reliable handbag system and method to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, handbag system, constructed and operative according to the teachings of the present disclosure.

FIG. 1 shows a handbag system during an ‘in-use’ condition according to an embodiment of the disclosure.

FIG. 2 is a perspective view illustrating an interior of a handbag system assembly according to an embodiment of the present invention of the disclosure.

FIG. 3 is a perspective view illustrating an exterior of the handbag system assembly according to an embodiment of the present disclosure.

FIG. 4 is an exploded view illustrating the handbag system assembly according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a handbag system and more particularly to a handbag having an inbuilt electrical charging means and a plurality of detachable pockets as used to improve handbag systems and methods.

Generally speaking, the present invention provides a highly functional, interactive, and stylish handbag which comprises an assembly of personal and electronic inner and outer storage compartments, attachable and detachable pockets and straps, an integrated mobile device battery charger, a retractable charging cable, an NFC blocker, a shielded pocket and securing mechanisms.

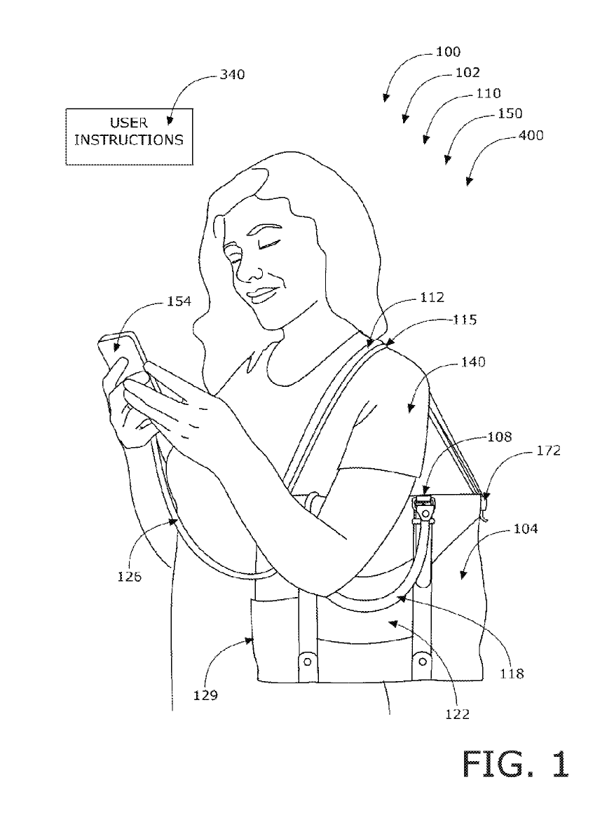

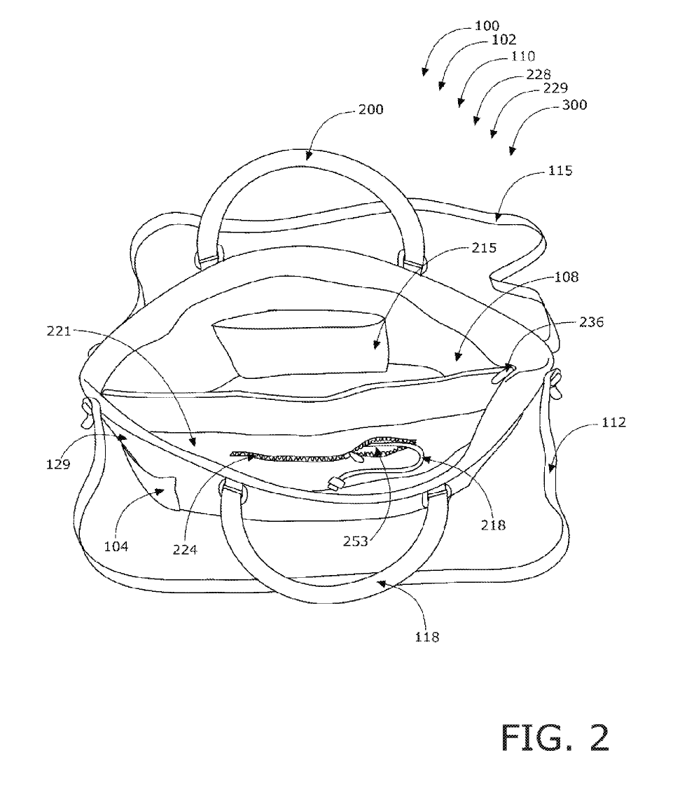

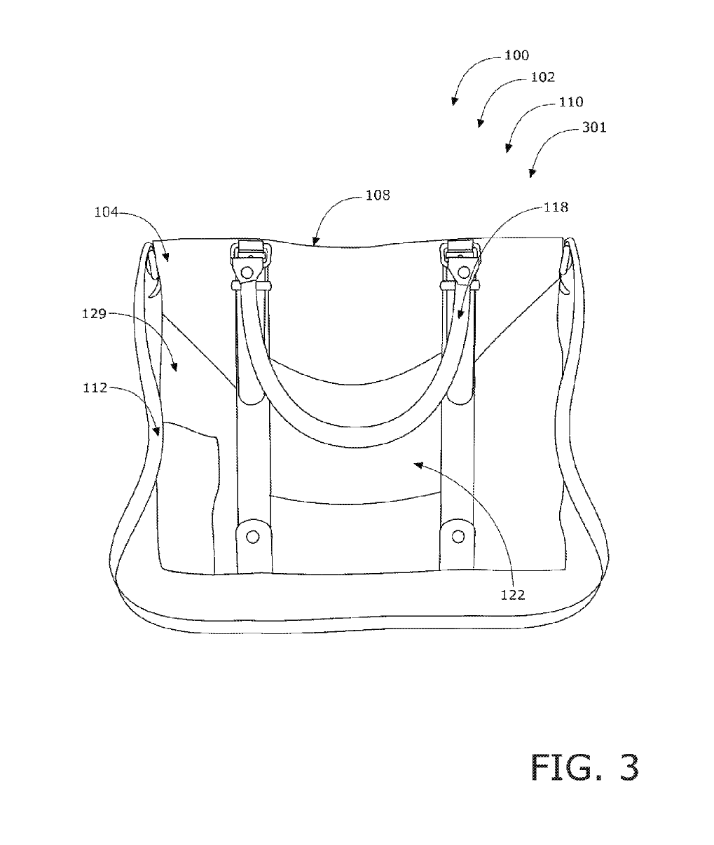

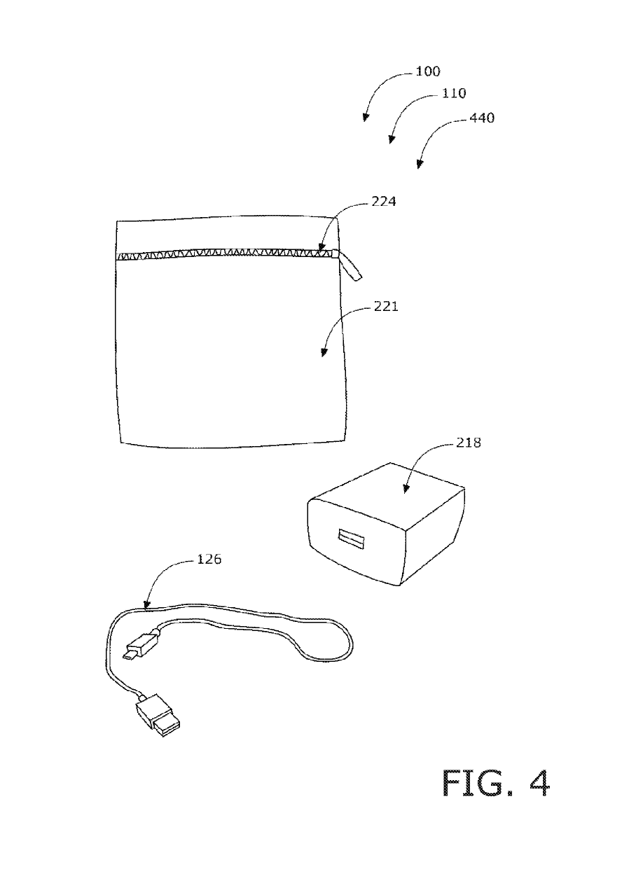

Referring now more specifically to the drawings by numerals of reference there is shown in FIGS. 1-4, various views of a handbag system 100, and more particularly, handbag system 100 having an inbuilt electrical charging means comprising: a charging pocket 122, integrated mobile device compartment 253, integrated mobile device battery charger 218, and retractable charging cable 126 configured to enable user 140 to conveniently store and maintain energy in cellular phone 154 during physical transport.

User 140 may choose to transport handbag system 100 by slinging first shoulder strap 112 and second shoulder strap 115 around a shoulder of choice of user 140 or by grasping and carrying handbag system 100 by first side handle 118 and second side handle 200. In choosing to transport handbag system 100 by slinging first shoulder strap 112 and second shoulder strap 115 around the shoulder of choice of user 140, user 140 may obtain access to the cellular phone 154 by manipulating handbag securing mechanism 236 comprising zipper 240, utilizing handbag opening 108 configured to provide access to inner opening of the handbag system 100, and accessing the cellular phone 154 from at least one detachable storage pocket 215 and integrated mobile device compartment 253 within an inner volume of handbag system 100.

Cellular phone 154 may actively obtain an energy charge while being stored within handbag system 100 via integrated mobile device battery charger 218 coupled with retractable charging cable 126. Retractable charging cable 126 coupled and connected with integrated mobile device battery charger 218 may provide a continued cellular phone energy charge to cellular phone 154 while being stored inside handbag system 100 or during transport by user 140. User 140 may actively operate cellular phone 154 and simultaneously obtain a cellular phone energy charge as long as cellular phone 154 is connected to retractable charging cable 126 and retractable charging cable 126 is coupled with integrated mobile device battery charger 218.

Handbag assembly 101 may maximize ease of use and functionality in that it may comprise at least one detachable shoulder strap 172, at least one detachable storage pocket 215, thermally insulated elastic sleeve 129 to transport and contain 16-ounce water bottle 245 or other beverage container of a comparable size, at least one detachable shoulder strap 172 having a first-attacher fixed to the first end and a second-attacher fixed to the second end.

Handbag outer shell 104 may be at least partially made of leather, fabric textile or vinyl polymer 204 and configured to have at least one storage compartment enclosure 210, inner surface 300, and outer surface 301 constructed to hold at least one technical item 193 such as a cellular phone, laptop, tablet and the like. Handbag outer shell 104 may further comprise forward end 228 and rearward end 229, shoulder strap(s) 120, handbag opening 108 configured to provide access to the inner volume of handbag assembly 101, a first shoulder strap attachment fixed to handbag outer shell 200 proximate forward end 112, a second shoulder strap attachment fixed to handbag outer shell 200 proximate rearward end 115, first side-handle fixed to outer handbag shell 118, and second side-handle fixed to outer handbag shell 200. Further, in one embodiment, forward end 112 may be situated substantially opposite rearward end 229 and configured to accommodate at least one locking mechanism. In another embodiment, handbag opening 108 may be structured to conceal inner contents of handbag assembly 101.

Additionally, handbag system 100 may comprise shielded pocket 221 with a securing mechanism to close shielded pocket 224 which may house an internal NFC blocker 440 (“Near Field Communication”) and may secure belongings such as credit cards, bank cards, passports and the like from events such as electronic pickpocketing and payment card clashing resulting in double payments for single purchases.

Handbag system 100 may be sold as a kit 340 comprising the following parts: at least one handbag outer shell 104; at least one first detachable shoulder strap 112; at least one second detachable shoulder strap 115; a first side-handle 118; at least one second side-handle 200; at least one detachable storage pocket 215; at least one charging-pocket 122 which may be configured to charge a mobile device 243, at least one shielded pocket 221; and at least one set of user instructions. The kit has instructions such that functional relationships are detailed in relation to the structure of the invention (such that the invention can be used, maintained, or the like in a preferred manner).

Handbag system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

A method of use 400 for handbag system 100 may comprise the steps of: step one, obtaining augmented handbag 401; step two, filling at least one elastic sleeve of outer covering 402; step three, opening zip-fastener of outer covering to gain access to inner volume 403; step four, attaching or reattaching storage pockets 404; step five, accessing first-pocket having a retractable lanyard attachment and built-in mobile device battery charger and second-pocket having an NFC blocker 440; step six, utilizing first-pocket having a retractable lanyard attachment and built-in mobile device battery charger and second-pocket having an NFC security blocker 406; step seven, closing zip-fastener of outer covering to secure contents of inner volume 407; step eight, grasping the attached first and second side-handles or detachable shoulder strap 408; and step nine, carrying outer covering with inner contents of inner volume 409.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An augmented handbag comprising:
a handbag outer shell having an inner surface, an outer surface, a forward end, and a rearward end, the forward end being substantially opposite the rearward end, the outer handbag shell being configured to hold personal items in an inner area substantially within the inner surface, the outer handbag shell including
a handbag opening configured to provide access to the inner area,
a handbag securing mechanism configured to close the handbag opening,
a first shoulder strap attachment fixed to the handbag outer shell proximate the forward end,
a second shoulder strap attachment fixed to the handbag outer shell proximate the rearward end;
a detachable shoulder strap having a first-end, a second-end, and a length, said length extending between the first-end and the second-end, the detachable shoulder strap including a first-attacher fixed to the first end and a second-attacher fixed to the second end;
a first side-handle fixed to the outer handbag shell on a first side of the handbag opening; and
a second side-handle fixed to the outer handbag shell on a second side of the handbag opening, the first side being substantially opposite the second side, relative to the handbag opening;
at least one detachable storage pocket detachably fixed to the outer handbag shell within the inner area; and
a charging-pocket fixed to the outer handbag shell, the charging-pocket including
an integrated mobile device battery charger, and
a retractable charging cable configured to electronically couple with and charge a mobile device via the mobile device battery charger; and
a shielded-pocket including
a securing mechanism configured to close to the shielded-pocket.
a NFC blocker configured to prevent nearfield communications with items in the shielded-pocket when the shielded-pocket is closed via the securing mechanism.

2. The augmented handbag of claim 1, wherein said handbag outer shell is configured to hold at least one shoulder strap.

3. The augmented handbag of claim 1, wherein said inner surface is constructed to hold at least one technical item.

4. The augmented handbag of claim 1, wherein the outer surface is configured to hold at least one attachable and detachable pocket.

5. The augmented handbag of claim 1, wherein said forward end is substantially opposite the rearward end and configured to accommodate at least one locking mechanism.

6. The augmented handbag of claim 1, wherein said rearward end is substantially opposite the forward end and configured to accommodate the structure of said handbag.

7. The augmented handbag of claim 1, wherein the handbag opening is structured to conceal the inner contents of said handbag.

8. The augmented handbag of claim 1, wherein said handbag comprises an integrated mobile device compartment to hold and easily transport a mobile device.

9. The augmented handbag of claim 1, wherein the integrated mobile device comprises a battery charger.

10. The augmented handbag of claim 1, wherein said integrated mobile device battery charger includes an energy storage configured to supply charging energy to the retractable charging cable.

11. The augmented handbag of claim 1, wherein said handbag outer shell is configured to have at least one storage compartment enclosure.

12. The augmented handbag of claim 1, wherein said handbag outer shell is at least partially made of leather, fabric textile, or vinyl polymer.

13. The augmented handbag of claim 1, wherein said handbag securing mechanism include a zipper.

14. The augmented handbag of claim 1, wherein said handbag outer shell includes an elastic sleeve in functional combination with said handbag outer shell.

15. The augmented handbag of claim 14, wherein said elastic sleeve is configured to retain a 16-ounce water bottle.

16. The augmented handbag of claim 1, wherein said elastic sleeve is thermally insulated.

17. The augmented handbag of claim 1, wherein said charging-pocket and said shielded-pocket are structured and arranged in functional combination with the augmented handbag to charge a mobile device and to provide digital and monetary anti-theft protection.

18. An augmented handbag comprising:
a handbag outer shell having an inner surface, an outer surface, a forward end, and a rearward end, the forward end being substantially opposite the rearward end, the outer handbag shell being configured to hold personal items in an inner area substantially within the inner surface, the outer handbag shell including
a handbag opening configured to provide access to the inner area,
a handbag securing mechanism configured to close the handbag opening,
a first shoulder strap attachment fixed to the handbag outer shell proximate the forward end,
a second shoulder strap attachment fixed to the handbag outer shell proximate the rearward end;
a detachable shoulder strap having a first-end, a second-end, and a length, said length extending between the first-end and the second-end, the detachable shoulder strap including a first-attacher fixed to the first end and a second-attacher fixed to the second end;
a first side-handle fixed to the outer handbag shell on a first side of the handbag opening; and
a second side-handle fixed to the outer handbag shell on a second side of the handbag opening, the first side being substantially opposite the second side, relative to the handbag opening;
at least one detachable storage pocket detachably fixed to the outer handbag shell within the inner area; and
a charging-pocket fixed to the outer handbag shell, the charging-pocket including
an integrated mobile device battery charger, and
a retractable charging cable configured to electronically couple with and charge a mobile device; and
a shielded-pocket including
a securing mechanism configured to close to the shielded-pocket.
a NFC blocker configured to prevent nearfield communications with items in the shielded-pocket when the shielded-pocket is closed via the securing mechanism.

19. The augmented handbag of claim 18, further comprising a set of user instructions;
wherein the handbag outer shell, the detachable shoulder strap, the first side-handle, the second side-handle, the detachable storage pocket, the charging-pocket, the shielded-pocket, and the set of user instructions are configured as a kit.

20. A method of using an augmented handbag, the method comprising the steps of:
obtaining the augmented handbag, the augmented handbag including a handbag outer shell, a detachable shoulder strap, a first side-handle, a second side-handle, at least one detachable storage pocket, a charging-pocket, and a shielded-pocket;
filling at least one elastic sleeve of outer covering with a bottle or thermal beverage container;
opening zip-fastener of outer covering to gain access to inner volume;
attaching or reattaching storage pockets located alongside inner volume;
accessing first-pocket having a retractable lanyard attachment and built-in mobile device battery charger and second-pocket having an NFC security blocker;
utilizing first-pocket having a retractable lanyard attachment and built-in mobile device battery charger and second-pocket having an NFC security blocker;
closing zip-fastener of outer covering to secure contents of inner volume;
grasping the attached first and second side-handles or detachable shoulder strap; and
carrying outer covering with inner contents of inner volume.
